(19) United States
(12) Patent Application Publication
(10) Pub. No.: US 2005/0016312 A1
(43) Pub. Date: Jan. 27, 2005

(54) Control device for a bicycle derailleur

(75) Inventor: Giuseppe Dal Pra', Zane (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 10/835,778

(22) Filed: Apr. 30, 2004

(30) Foreign Application Priority Data
Apr. 30, 2003 (EP) 03425279.1

(51) Int. Cl. B60K 17/04

(52) U.S. Cl. 74/484 R; 74/473.12

(57) ABSTRACT

A control device for a bicycle derailleur has a supporting body that can be fixed to the handlebar and which can be gripped by the cyclist and which has an internal side wall and an external side wall, which are substantially parallel to the plane of a respective curved end of the handlebar. The device has an actuator for actuating the derailleur towards higher or lower gear ratios, controlled by means of one a first and one a second control member. The two control members are both arranged on the internal side wall of the supporting body, in a position that can be reached by the cyclist's thumb when his hand is in its normal operating position.

### FIELD OF INVENTION

The field of the invention is bicycles, particularly racing bicycles.

### BACKGROUND

Control devices that integrate the control of a derailleur and the control of a brake of the bicycle in a single device are known. This dual control is often contained in a single supporting body that is fixed to the bicycle's handlebar. The derailleur actuator is controlled by two levers on the supporting body.

The prior art teaches the two-lever derailleur controller. In the controller, a first control lever extends along and behind a brake lever and can be actuated in a direction transverse to the movement direction of the brake lever for controlling the derailleur in a first operating direction. A second control lever projects from the internal side wall of the supporting body and can be actuated in a substantially vertical direction for controlling the derailleur in the opposite operating direction.

Another two-lever configuration is also known. The first control lever coincides with the brake lever, which can be actuated in this case according to two directions transverse to one another: one direction applies the brakes and the other controls the derailleur in a first operating direction. A second control lever extends behind the brake lever and controls the derailleur in the opposite operating direction.

In the known devices above, the control lever of the derailleur, whether it is set behind the brake lever or coincident with the brake lever, is typically controlled with one or more of the cyclist's fingers by pushing it in a transverse direction from the outside towards the inside of the handlebar. The lever projecting from an internal side wall of the supporting body is, in contrast, controlled typically by the cyclist's thumb. An elastic means returns the control levers to their neutral starting position after each actuation.

In the traditional configuration, the control device mounted on the right end of the handlebar controls the rear derailleur and the rear brake, whilst the left control device controls the front derailleur and the front brake.

The spread of integrated control devices of the type above has led cyclists to use the supporting bodies of the two integrated brake-derailleur controls mounted on the two ends of the handlebar as true appendages of the handlebar. When the cyclist is riding the bicycle, according to his different posture and style, the cyclist may grip the supporting body directly, as represented in FIG. 2. It is thus critical that whether the cyclist is in the position shown in FIG. 1 or 2, he has control over the derailleur.

With either of the positions in FIGS. 1 and 2, the above mentioned types of control devices have certain drawbacks. A first drawback is that the cyclist must loosen his grip on the handlebar in order to apply thrust to the levers. This involves a reduction in the pressure of the hand on the handlebar and the consequent loosening of grip, with possible loss of control for the cyclist, especially on rough paths.

Another drawback is that the gear-shifting operation, both when shifting upwards and when shifting downwards, may result in loss of control for a cyclist with small hands because the actuation levers are too far away for easy access. To reach the levers, the cyclist with small hands must remove his whole hand from the supporting body to activate the lever.

### SUMMARY

A control device for a bicycle derailleur comprises 1) a supporting body that can be fixed to a bicycle handlebar and can be gripped by a cyclist and which has an internal side wall and an external side wall that are substantially parallel to the plane of a respective curved end of the handlebar;
2) actuator means of said derailleur that can be controlled in two opposite directions for controlling the movement of the derailleur towards either higher or lower gear ratios; and
3) a first control member and a second control member, for activating said actuator means in said two opposite directions;
wherein said first and second control members are both arranged on said internal side wall of said supporting body.

### BRIEF DESCRIPTION OF THE DRAWING(S)

FIGS. 1 and 2 are perspective views of two types of grip of the cyclist's hand;

FIG. 3 is a perspective view of a first embodiment of the control device;

FIG. 4 illustrates the device of FIG. 3 gripped by a cyclist's hand;

FIG. 5 is a perspective view of a variant of the device of FIG. 3;

FIG. 6 is a side view of a second embodiment of the control device;

FIG. 7 is a front view, partially sectioned according to the line VII-VII, of the device of FIG. 6;

FIG. 8 is a side view of a third embodiment of the control device;

FIG. 9 is a front view of the device of FIG. 8, with a detail sectioned according to the line IX-IX of FIG. 8;

FIGS. 10 and 11 are a plan view and a side view, respectively, of a further embodiment of the device;

FIG. 12 illustrates a front view of another variant of the control device;

FIG. 12A illustrates at an enlarged scale a detail of FIG. 12;

FIG. 13 is a side view of the device of FIG. 12 applied to an handlebar gripped by the cyclist;

FIGS. 14 and 15 are a side view and a front view, respectively, of a further variant of the control device;

FIG. 14A illustrates a detail in a cross-sectional view corresponding to the line XV-XV of a variant of FIG. 14;

FIG. 16 is a side view of a further variant; and

FIG. 17 is a front view of the device of FIG. 16, with a detail sectioned according to the line XVII-XVII.

### DETAILED DESCRIPTION OF THE PREFERRED EMBODIMENT(S)

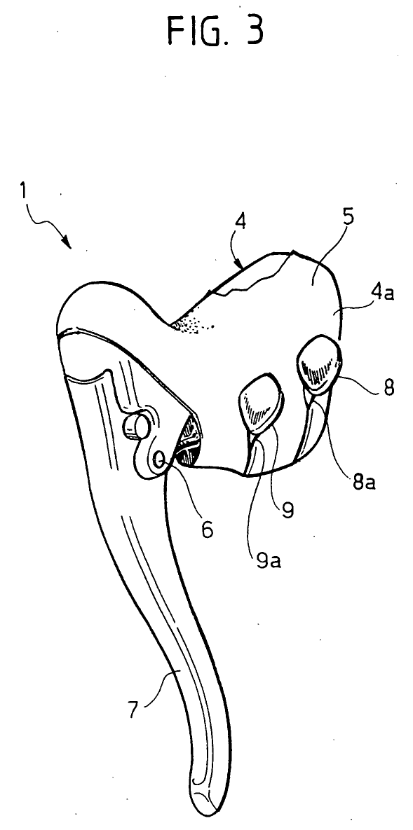

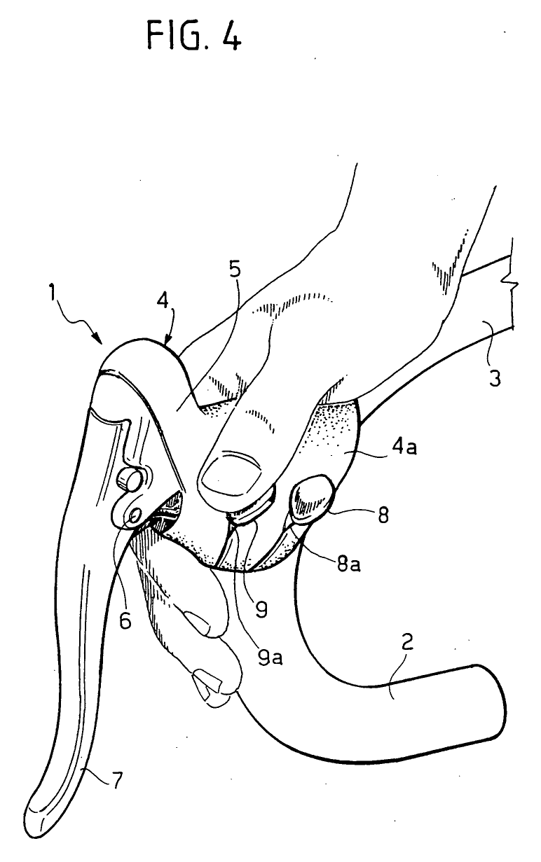

FIG. 3 shows a control device 1 designed to be mounted on the curved end 2 (see FIG. 4) of a handlebar 3 of a bicycle. The device 1 comprises a hollow supporting body 4, usually made of metal that is covered with a protective sheath or hood 5 made of elastomeric material. A brake lever 7 attached to the supporting body 4 via an articulation pin 6 actuates a brake through a flexible control cable (not shown). The supporting body 4 functions also as a shell or casing for a mechanism for actuation of a bicycle derailleur. The right-hand control usually controls the rear bicycle derailleur, while the front derailleur is controlled by a similar left-hand control mounted on the left end of the handlebar.

Two keys 8, 9 projecting from a side wall 4a set on the inner side of the supporting body 4 (opposite a parallel sidewall 4b shown in profile in FIG. 7), i.e. facing the central median plane of the handlebar control the derailleur's actuation mechanism. The two keys 8, 9 are mounted on ends of respective actuating arms 8a, 9a.

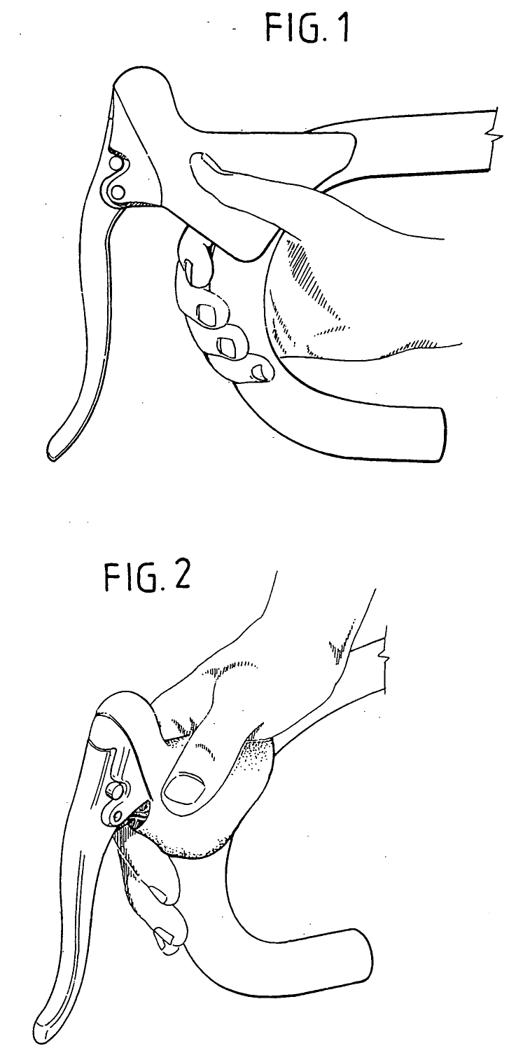

FIG. 4 shows the position of the two keys 8, 9 that enable the cyclist to actuate them without modifying his hand position on the supporting body 4, allowing him to easily reach and actuate the brake lever 7. In particular, the cyclist may actuate each key 8, 9 with his thumb when he grips the handlebar, as illustrated in FIG. 1, and without moving or adjusting his hand, also actuate the brake lever 7 with his other fingers. The solution represents, therefore, a substantial change as compared to the known devices, which at the most foresee a single control lever for the derailleur on the internal side wall 4a of the supporting body 4.

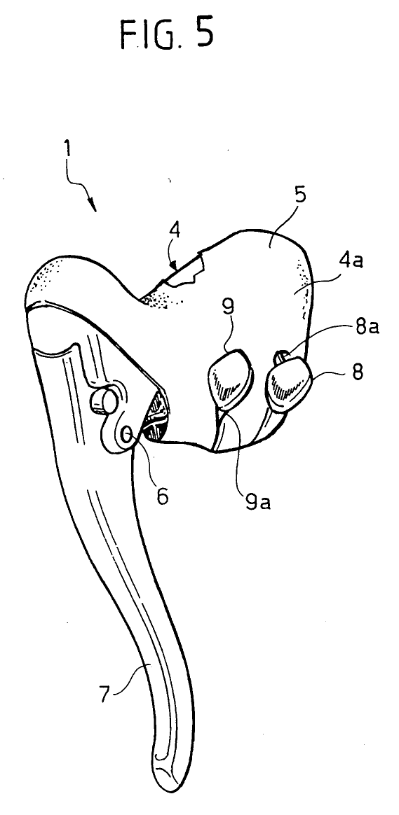

FIG. 5 illustrates a variant of the device of FIG. 3 and differs from the latter in the different position of the key 8, which is positioned slightly lower than key 9.

In the embodiments of FIGS. 3-5, the actuating arms 8a, 9a and the respective keys 8, 9 can be arranged for displacement in a substantially vertical direction, or else in a direction inclined with respect to said vertical direction. In addition, the movement of the actuating arms 8a, 9a may rotate about an axis, or may move linearly.

Although they are not shown, elastic means attached to actuating arms 8a, 9a return each arm into a neutral position after its actuation. These elastic means may include springs, a cable in tension, a piece of plastic material, or rubber. In the case illustrated, each actuating arm 8a, 9a is displaced downwards starting from its resting position illustrated and returns automatically upwards following upon each actuation.

In the case of mechanical actuators, each actuating arm 8a, 9a, through respective ratchet-mechanism means, controls the rotation of a pulley that winds a flexible control cable of the derailleur, respectively, in the winding direction or in the unwinding direction. If so desired, one of the two arms may be for “release,” i.e., designed to cause rotation of the pulley in the unwinding direction of the cable by simply leaving it temporarily free to rotate by the elastic means associated with the rear derailleur.

In the electrical actuators, each actuating arm 8a, 9a acts, with the end opposite the push-buttons 8, 9 end, on electrical switches that actuate the electric motor associated to the derailleur.

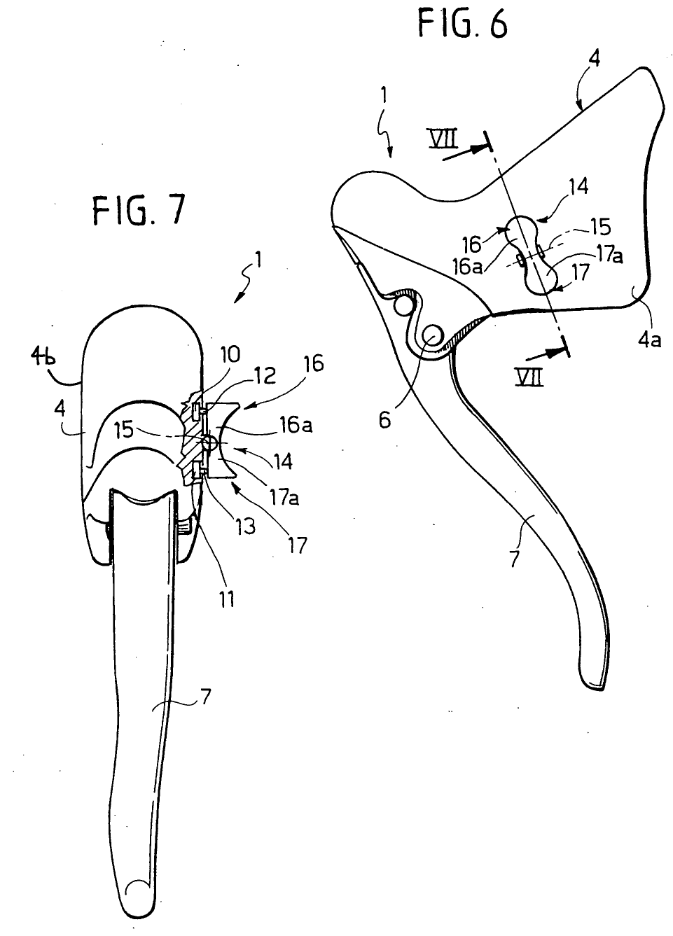

FIGS. 6 and 7 illustrate a second embodiment of the control device of the invention, in which the derailleur is actuated by an electric actuator means. For this embodiment, the derailleur has an electric actuating motor. For a rear derailleur, the electric motor controls the geometry of an articulated parallelogram forming part of the derailleur itself, by means of an external-thread/internal-thread system, as illustrated in U.S. Pat. No. 5,479,776. Two respective electrical switches 10, 11 incorporated in the supporting body 4 of the device control the electric motor gear-shifting either towards higher ratios or towards lower ratios by means of the actuator. The two electrical switches 10, 11 both present a mobile element 12, 13, respectively, that is returned by elastic means (not illustrated) to a position where it is extracted and where it can be actuated, against the action of said elastic means, by a single body 14 rotating around an axis 15.

The body 14 is defined by the two actuating arms 16a, 17a, the ends of which constitute the actuating keys 16, 17 controllable by the cyclist's thumb without the cyclist having to substantially displace his hand from the normal operating position. As it may be seen, the axis 15 is parallel to the internal side wall 4a of the supporting body 4 and is substantially parallel to the longitudinal direction of the bicycle (with reference to the mounted condition of the device).

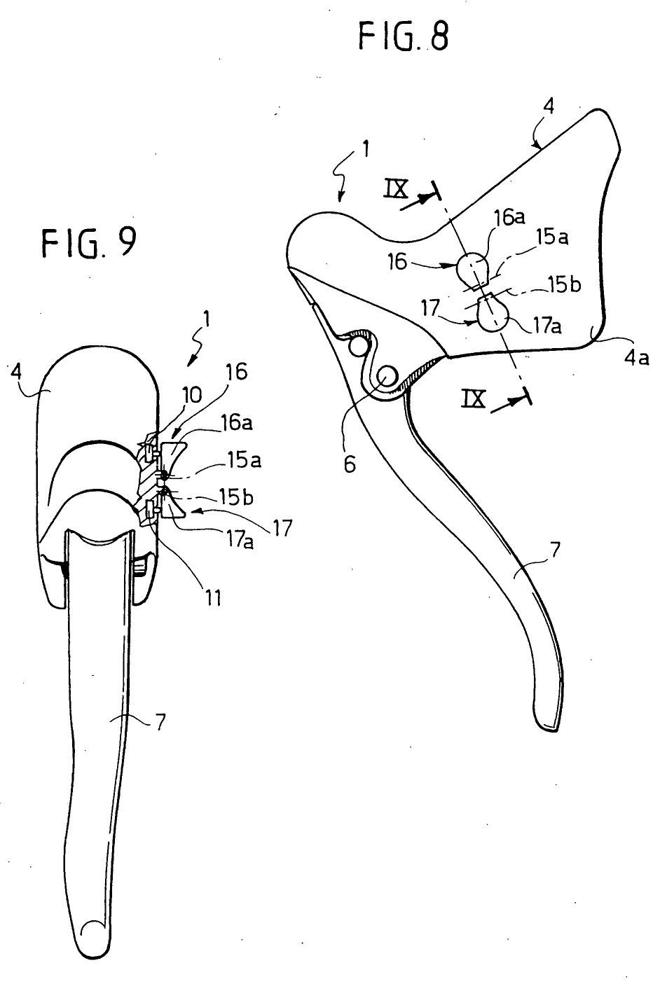

The device shown in FIGS. 8 and 9 differ from the one represented in FIGS. 6 and 7 in that the actuating arms 16a, 17a and the respective keys 16, 17 are separate bodies that oscillate around two parallel and distinct axes 15a, 15b. In such an embodiment as is shown in FIGS. 6 and 7, the actuating keys 16, 17 may be conveniently controlled by the cyclist's thumb without the cyclist having to displace his hand substantially from the normal operating position. The solution with distinct axes allows different positions and orientations of the keys 16, 17 according to different configurations, for example with non-parallel axes, according to the requirements or needs of the cyclist.

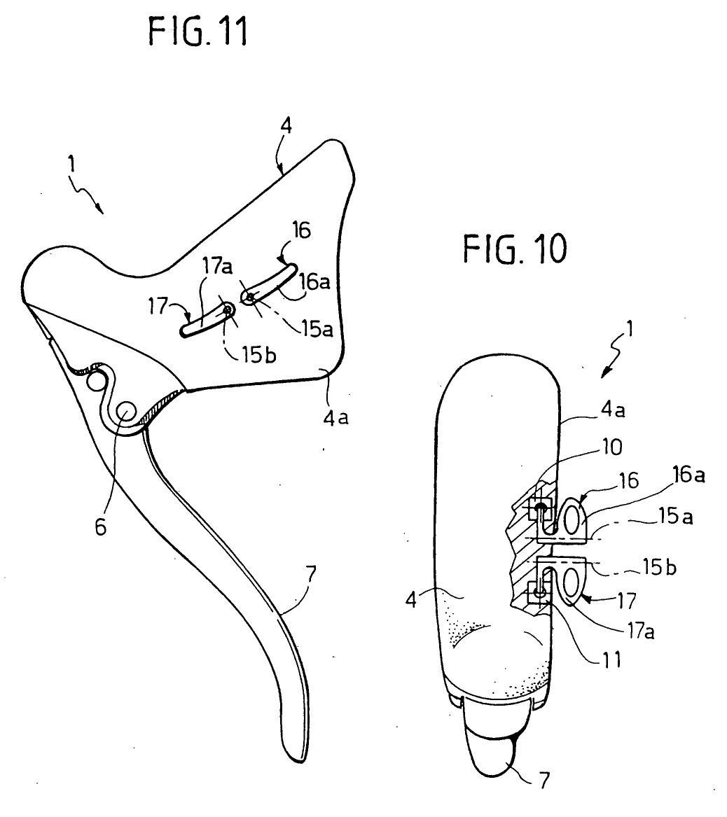

FIGS. 10 and 11 show another embodiment with two separate actuating arms 16a, 17a for the actuation of the two switches 10, 11 and presents axes 15a, 15b perpendicular to the internal side wall 4a. The keys 16, 17 are actuated, respectively, with a clockwise and counterclockwise movement around the axes 15a, 15b according to the view of FIG. 11 and are easily controllable by the cyclist's thumb without the cyclist having to displace his hand substantially from its normal operating position.

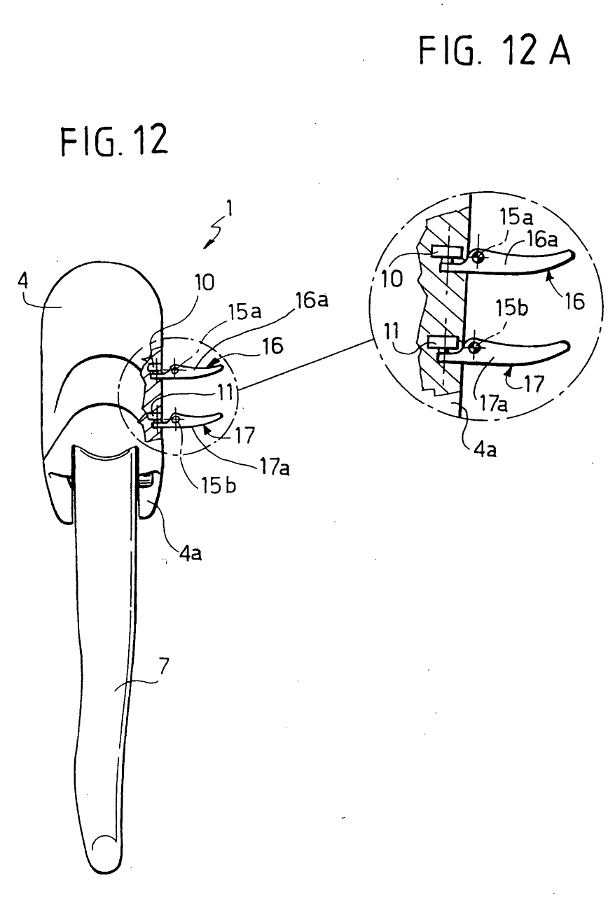

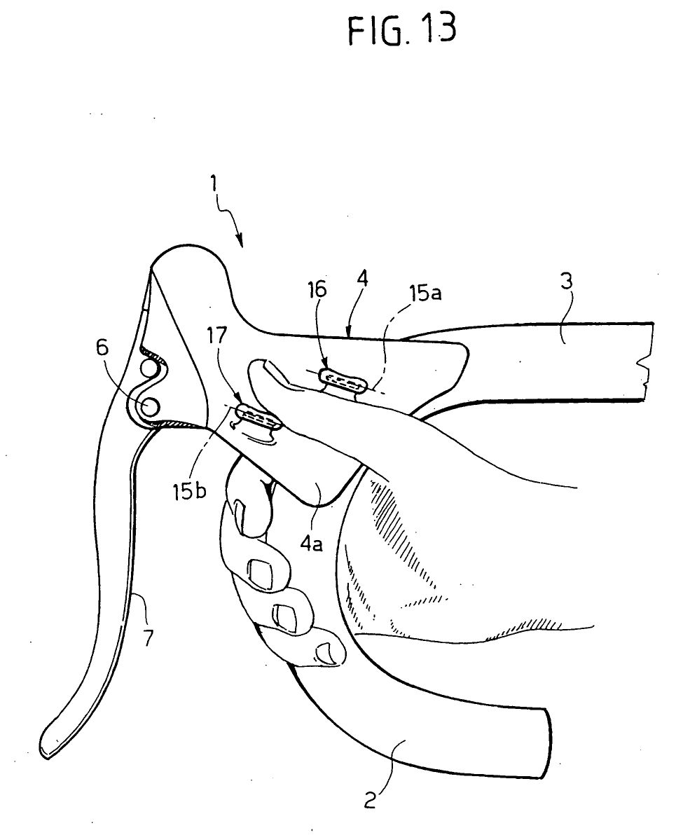

FIGS. 12 and 13 show two actuating arms 16a, 17a that actuate two switches 10, 11; the axes 15a, 15b are parallel to the internal side wall 4a. The keys 16, 17 are actuated with a top-down movement and are easily controllable by the cyclist's thumb without the cyclist having to substantially displace his hand from its normal operating position. FIG. 13 shows how the cyclist may control each key 16, 17 in a convenient way with his thumb while gripping the handlebar. In a variant (not shown), the keys 16, 17 could assume the configuration of FIG. 13 and be actuated both by the cyclist's thumb in the position represented in FIG. 13 by pushing the key 17 downwards and the key 16 upwards without substantially displacing the position of his thumb.

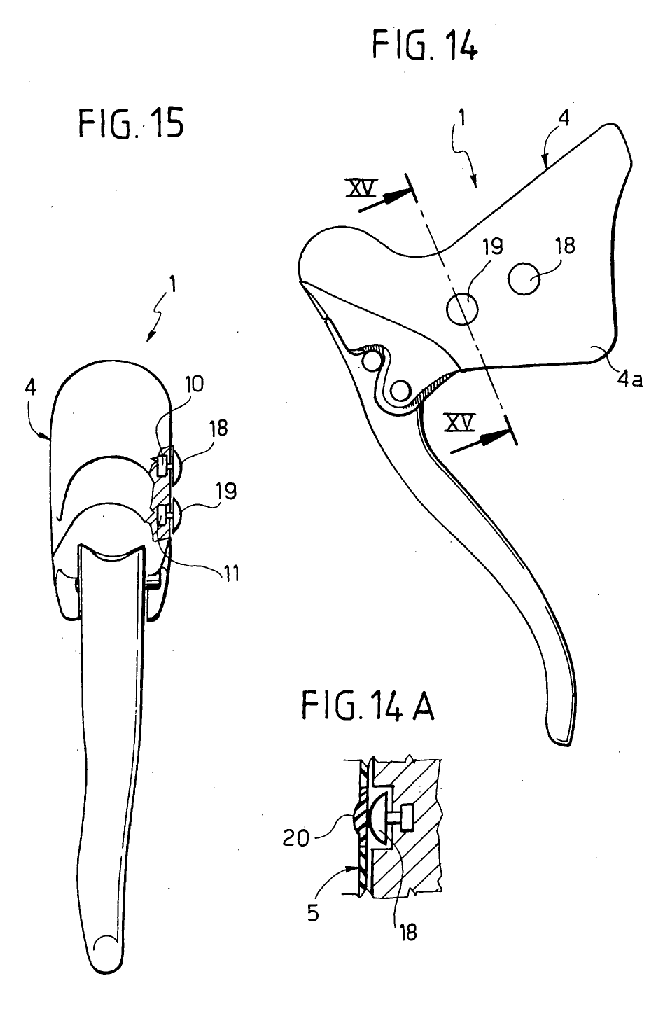

FIGS. 14 and 15 show the two electrical switches 10, 11 controlled by two push-buttons 18, 19 arranged on the internal side wall 4a of the supporting body 4. The push-buttons 18, 19 are returned elastically towards a neutral resting position by elastic means incorporated in the respective electrical switches 10, 11 or by auxiliary elastic means (not illustrated).

For the embodiment in FIGS. 14 and 15, the protective sheath 5 is preferably made of an elastomeric material that covers the supporting body 4 and has areas with decreased softness (preferably a Shore A hardness of about 30-35 compared to the remaining sheath that has a Shore A hardness of about 55-60) corresponding to the two push-buttons 18, 19 so as to protect and seal the two switches 10, 11 and at the same time enable touch sensitivity for the cyclist. Such a solution is shown in FIG. 14A that shows an insert 20 mounted in a corresponding opening obtained in the wall of the protective sheath 5, in a position corresponding to each of the two push-buttons 18, 19. The insert 20 may have a shaped and/or colored outer surface that enables the cyclist to identify easily, even just by touch, the area of the push-button.

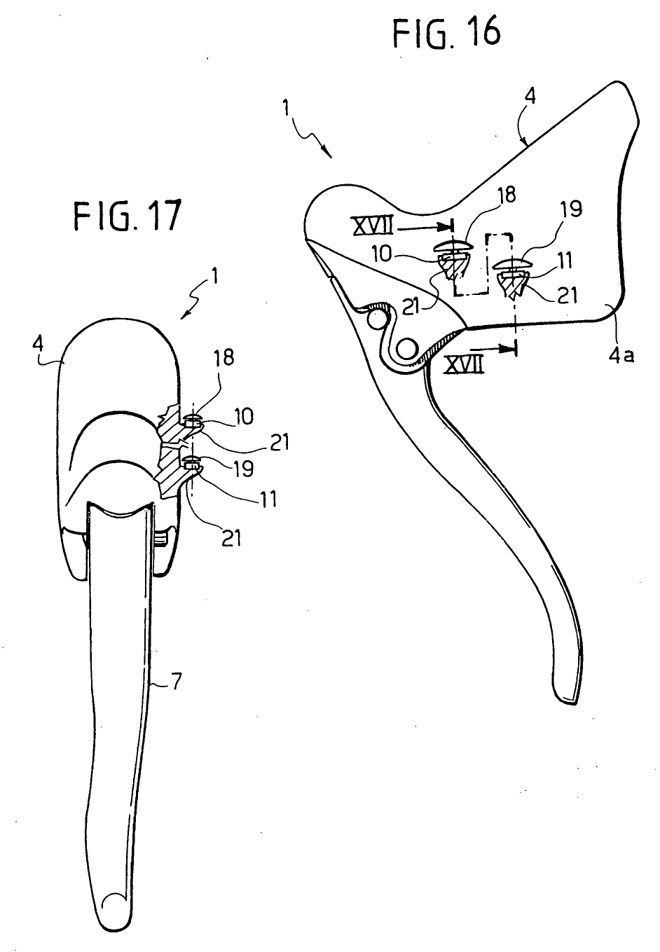

Finally, FIGS. 16 and 17 show two electrical switches 10, 11 controlled by means of push-buttons 18, 19. In this case, the switches are carried by two appendages 21 of the supporting body 4 so as to have an operating direction corresponding to the displacement of the cyclist's thumb in a substantially vertical direction.

The solutions above can be used with an actuator means of an electrical type or of a mechanical type for derailleurs with electrical or mechanical actuation. Of course, without prejudice to the principle of the invention, the details of construction and the embodiments may vary widely with respect to what is described and illustrated herein purely by way of example, without thereby departing from the scope of the present invention.

1. A control device for a bicycle derailleur comprising:
a supporting body that can be fixed to a bicycle handlebar and can be gripped by a cyclist and which has an internal side wall and an external side wall that are substantially parallel to the plane of a respective curved end of the handlebar;
actuator means of said derailleur that can be controlled in two opposite directions for controlling the movement of the derailleur towards either higher or lower gear ratios; and
a first control member and a second control member, for activating said actuator means in said two opposite directions;
wherein said first and second control members are both arranged on said internal side wall of said supporting body.

2. The device of claim 1 wherein said first and second control members are easily reachable by the cyclist's thumb without the cyclist substantially displacing his hand from an operating position.

3. The device of claim 1 wherein said first and second control members are easily reachable by the cyclist's thumb without the cyclist substantially displacing his hand from the supporting body.

4. The device of claim 1 wherein said first and second control members are easily reachable by the cyclist's thumb without the cyclist substantially displacing his hand from the handlebar.

5. The device of claim 1 wherein said derailleur is a front derailleur.

6. The device of claim 1 wherein said derailleur is a rear derailleur.

7. The device of claim 1 wherein said actuator means comprise electrical control means.

8. The device of claim 7 wherein said electrical control means comprise an electric motor which co-operates mechanically with said derailleur.

9. The device of claim 8 wherein said electric motor co-operates mechanically with said derailleur by means of an articulated quadrilateral mechanism.

10. The device of claim 1 wherein said actuator means are of a mechanical type.

11. The device of claim 10 wherein said actuator means of a mechanical type are carried by said supporting body.

12. The device of claim 11 wherein said actuator means of a mechanical type comprise ratchet-mechanism means.

13. The device of claim 1 wherein said first and second control members are in the form of two actuating keys projecting from said internal side wall of said supporting body.

14. The device of claim 1 wherein said first and second control members are in the form of actuating push-buttons.

15. The device of claim 14 wherein said actuating push-buttons project from said internal side wall.

16. The device of claim 1 wherein said first control member is an actuating key and said second control member is an actuating push-button.

17. The device of claim 1 wherein said first and second control members may be displaced between a resting position and an operating position.

18. The device of claim 17 wherein said first and second control members comprise means of recall towards said resting position.

19. The device of claim 18 wherein said means of recall comprise elastic means.

20. The device of claim 13 wherein said keys constitute the ends of actuating arms mounted on the supporting body in a direction chosen among: a substantially vertical direction, a substantially longitudinal direction, and a direction that is substantially inclined both with respect to the vertical direction and with respect to the longitudinal direction.

21. The device of claim 13 wherein said keys are aligned with respect to one another according to a direction chosen among: a substantially vertical direction, a substantially longitudinal direction, and a direction that is substantially inclined both with respect to the vertical direction and with respect to the longitudinal direction.

22. The device of claim 13 wherein said keys are arranged staggered with respect to one another in the axial direction of actuation of the cyclist's thumb.

23. The device of claim 20 wherein said actuating arms are slidably mounted on the supporting body.

24. The device of claim 20 wherein said actuating arms are rotatably mounted around two respective axes.

25. The device of claim 24 wherein said axes are parallel to one another.

26. The device of claim 24 wherein said axes are not parallel.

27. The device of claim 20 wherein said actuating arms are mounted oscillating around one common axis.

28. The device of claim 27 wherein said keys are positioned on opposite sides with respect to said common axis.

29. The device of claim 27 wherein said actuating arms constitute a single member rocking around said common axis.

30. The device of claim 20 wherein said actuator means comprise electrical control means and wherein said actuating arms communicate with control switches of said electrical control means.

31. The device of claim 20 wherein said actuator means comprise electrical control means, wherein said actuator means are of a mechanical type and comprise ratchet-mechanism means, and wherein said actuating arms co-operate directly with said ratchet-mechanism means.

32. The device of claim 14 wherein said push-buttons may be actuated by pressure of the cyclist's thumb by a movement in a direction substantially orthogonal to said internal side wall.

33. The device of claim 15 wherein said push-buttons are mounted on appendages projecting from said side wall and actuatable by pressure of the cyclist's thumb by a movement in a direction substantially parallel to the plane of said internal side wall.

34. The device of claim 15 wherein said push-buttons are mounted on appendages projecting from said side wall and actuatable by pressure of the cyclist's thumb by a movement in a direction chosen among: a substantially vertical direction, a substantially longitudinal direction, and a direction that is substantially inclined both with respect to the vertical direction and with respect to the longitudinal direction.

35. The device of claim 7, wherein said first and second control members are in the form of actuating push-buttons and wherein said push-buttons act on control switches of said electrical control means.

36. The device of claim 1 wherein it comprises a covering sheath.

37. The device of claims 36 and 14 wherein said sheath has at least one area of interaction with said push-buttons.

38. The device of claim 37 wherein said area of interaction presents different softness with respect to the other areas that constitute said sheath.

39. The device of claim 37 wherein said area of interaction has an outer surface with a different texture than a texture of the remainder of the sheath.

40. The device of claim 37 wherein said area of interaction has a different color than other areas of the sheath.

41. The control device of claim 1 wherein said supporting body functions as support for a lever for the brake actuation.

42. A bicycle supporting body that supports a cyclist's hand comprising:
a support area for supporting the cyclist's hand;
a gear-shifting area substantially orthogonal to the support area, the gear shifting area providing thumb-operable means for controlling the operation of a derailleur.

43. The supporting body of claim 42 wherein the means for controlling controls the operation of a derailleur through an electrical actuator.

44. The supporting body of claim 42 wherein the means for controlling controls the operation of a derailleur through a mechanical actuator.

45. A bicycle control device that supports a cyclist's hand comprising:
a support area for supporting the cyclist's hand during riding of a bicycle;
a brake lever;
at least one thumb operable control configured to control the derailleur of a bicycle.

46. The bicycle control device of claim 45 wherein the at least one thumb operable control is at least one key that rotates about an axis substantially orthogonal to an axis about which the brake lever rotates.

47. The bicycle control device of claim 45 wherein the at least one thumb operable control comprises two buttons that, when depressed, activate an electrical actuator that controls the derailleur.

48. The bicycle control device of claim 45 wherein the thumb operable control comprises an area on the control device that is of a different softness than the remainder of the control device, and depression of the area activates an electrical actuator that controls the derailleur.

49. The bicycle control device of claim 48 wherein the area has a Shore A hardness of about 30-35.

50. A control device for a bicycle derailleur of a bicycle, the bicycle comprising a frame and an handlebar, the handlebar presenting a central part, connected to the frame, and two curved ends which extend in planes that are substantially perpendicular to the central part of the handlebar, said device comprising:
a supporting body, which can be fixed to said handlebar and can be gripped by a cyclist and which has an internal side wall and an external side wall that are substantially parallel to the plane of a respective curved end of the handlebar;
an actuator means of said derailleur, which can be controlled in two opposite directions for controlling the derailleur towards either higher or lower gear ratios; and
a first control member and a second control member, for activating said actuator means in said two opposite directions;
wherein said first and second control members are both arranged on said internal side wall of said supporting body in a position that can be reached by the cyclist's thumb when his hand is in its normal operating position.
